(19) United States
(12) Patent Application Publication
(10) Pub. No.: US 2003/0212849 A1
(43) Pub. Date: Nov. 13, 2003

(54) Coupling apparatus for the connection of devices to a bus system

(75) Inventors: Franz Josef Dold, Furtwangen (DE); Sebastian Brunsch, Mahlberg (DE); Oliver Koepcke, Neuenburg (DE)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Sick AG, Waldkirch/Breisgau (DE)

(21) Appl. No.: 10/388,380

(22) Filed: Mar. 12, 2003

(30) Foreign Application Priority Data
Mar. 18, 2002 (DE) 10211938.4

(51) Int. Cl. G06F 13/14

(52) U.S. Cl. 710/305

(57) ABSTRACT

A coupling apparatus is described for the connection of devices such as sensors, actuators, contact free protection devices (electro-sensitive protection equipment ESPE), light barriers or controls to a bus system. The coupling apparatus includes at least one connection unit at the bus side for the connection of the coupling apparatus to the bus system and at least one connection unit at the device side for the connection of a device to the coupling apparatus. The connection unit at the device side includes n (n>1) contact elements of which each has one pre-defined functional property from a set of m (m>1) pre-defined functional properties. At least some of the contact elements are designed as variable contact elements to each of which one of the pre-defined functional properties can be variably assigned.

The present invention relates to a coupling apparatus for the connection of devices such as sensors, actuators, contact free protection devices (electro-sensitive protection equipment—ESPE), light barriers or controls to a bus system, comprising at least one connection unit at the bus side for the connection of the coupling apparatus to the bus system and comprising at least one connection unit at the device side for the connection of a device to the coupling apparatus, with the connection unit at the device side including n (n>1) contact elements of which each has one functional property from a set of m (m>1) pre-defined functional properties.

Coupling apparatuses of this kind are used for the connection of devices both to normal bus systems and to security bus systems. For example, IP 20 field bus connections (connection units) thus exist which make possible both the connection of passive security switches and of active security light barriers to security bus systems on the basis of standard field bus protocols.

The solution approaches for the connection of the individual devices to the bus system is usually based with the protection class IP 20 on the fact that separate contact elements are available with the following functional properties (assignments):

static supply voltage (usually 24 volts)

potential ground (GND)

signal input 1 (IN1)

signal input 2 (IN2)

test output 1 (TOUT1)

test output 2 (TOUT2)

functional earth (FE)

With a coupling apparatus assigned in this manner, the connection of the three most important kinds of transducers, namely security switches, security light barriers and standard sensors, to a security bus system is possible, with the coupling apparatuses being able to be identical in all three cases. If these kinds of transducers should be connected in the protection class IP 67, at least the following industrially standardized plug connectors must be used in accordance with the applicable regulations:

IP 67 M12 8 pin

IP 67 M18 8 pin

IP 67 M23 12 pin

The use of these industrially standardized plug connectors, however, brings about problems. On the one hand, these three said plug connections are not commercial plug connections for standard sensors for which IP 67 M12 5 pin is usually used. A connection of standard sensors is thus not possible without problems.

On the other hand, a plug connection in accordance with IP 67 M12 8 pin can result in only limited currents due to wire cross-sections which are too small. These maximum currents are not sufficient for certain transducers. A further disadvantage consists of the fact that the said three plug connections cannot be independently configured by the user so that he has to use pre-configured cables, which limits the flexibility in the installation on site and increases the costs.

The plug connectors IP 67 M 18 and IP 67 M23, in contrast, have dimensions which are too large and result in higher plug connector costs at the transducer as well as at the connection unit.

It is an object of the present invention to design a coupling apparatus of the kind first mentioned such that a flexible connection of security sensors and standard sensors can be carried out with standardized cost-favorable plug connections. The flexible connection should in particular be possible for sensors of the protection class IP 67. Furthermore, in particular the demands on the security directed integration of security components in accordance with security category 4 (EN 954) should be satisfied.

Starting from a coupling apparatus of the kind initially named, this object is satisfied in accordance with the invention in that at least some of the contact elements are made as variable contact elements to each of which one of the pre-defined functional properties can be variably assigned.

With respect to the known coupling apparatuses in which each of the contact elements has a fixedly pre-determined, unchangeable pre-defined functional property, in the coupling apparatus in accordance with the invention, a variability of the functional properties of the individual contact elements, i.e. a parameterization of their function, is thus possible. It is achieved in this manner that coupling apparatuses with a lower number of contact elements can be used for the devices usually used in operation. In addition, inputs and outputs can be saved and an increased flexibility is produced for the user since he can thus independently reparameterize the coupling apparatuses in accordance with the invention such that the connection of the desired devices is made possible.

Finally, the use of already existing housings and terminal plug connectors is also possible with existing bus systems or devices. A cost-favorable standard plug connection, which can be used in accordance with the invention, is, for example, a plug connector in accordance with protection class IP 67 M12 5 pin.

In accordance with an advantageous embodiment of the invention, some of the contact elements are made as fixed contact elements to each of which one pre-set functional property is fixedly assigned, whereas any one functional property can be assigned to any one of the remaining variable contact elements. The hardware and software effort in the development and production of the coupling apparatuses can be reduced by the fixed assignment of individual contact elements. It only needs to be taken into account that a sufficient number of contact elements are made as variable contact elements in order to ensure the required flexibility for the connection of the different devices.

It is possible with the invention for at least some of the variable contact elements to be assigned the same functional property in each case or for at least some of the variable contact elements to be assigned functional properties different from one another. The respectively desired configuration is dependent on the application.

The number of contact elements m at the device side can be larger than, equal to or smaller than the number of pre-defined functional properties n. The selection of the corresponding number also depends here only on the desired application.

The pre-defined functional properties can advantageously be selected from the following properties: static supply voltage (positive or negative), ground (GND), signal input, test output, functional earth, switch output, signal input with pull-up resistance, signal input with pull-down resistance, zero volts and no function. All main combinations for the variable contact elements are pre-settable with these pre-defined functional properties so that the devices used in customary operation can be connected to every bus system via the coupling apparatus in accordance with the invention.

In accordance with an advantageous embodiment of the invention, one of the contact elements is made as a housing part of the connection unit at the device side. It is thereby possible to further reduce the actual number of pins of the coupling plug used. If, for example, six contact elements are required, a standard plug connector in accordance with protection class IP 67 M 12 5 pin can be used in which the housing is used as the sixth contact element.

The coupling apparatus is preferably designed for the connection of secure devices (security devices). The coupling apparatus is likewise preferably designed for the connection to a secure bus system (security bus system).

In accordance with a further advantageous embodiment of the invention, a functional earth is fixedly assigned to the housing contact. However, it is generally also possible for a functional earth not to be placed on the housing contact, but—with a sufficient number of contact elements—onto a separate contact pin.

In accordance with a further advantageous embodiment of the invention, a fixed contact element is fixedly set as the first signal input (IN1), a fixed contact element as the second signal input (IN2) and a fixed contact element as ground (GND), whereas two variable contact elements are each variably settable as the first test output (TOUT1) or as the second test output (TOUT2) or can have a static supply voltage or zero volts assigned to them. In this embodiment, two variable contact elements are thus provided which can optionally be used as test outputs with test sequences or be placed statically on supply voltage (for example 24 volts or zero volts). With this embodiment of the coupling apparatus in accordance with the invention, the connection of security switches, of security light barriers as well as of standard sensors to a security bus system is possible with a standardized plug connector IP 67 M12 5 pin, as will be explained in more detail with reference to the description of the Figures.

The realization of coupling devices with two-pin security outputs is also possible with the solution in accordance with the invention. For this purpose, in a preferred embodiment, a fixed contact element is fixedly set as ground (GND), whereas at least some of the remaining contact elements are made as variable contact elements and in each case two of the variable contact elements are settable as the first and the second test outputs (TOUT1H, TOUT2H) and the two other variable contact elements are settable in each case as low active first and second switch outputs (TOUT1L, TOUT2L). It is also possible in an alternative solution for the first and second test outputs (TOUT1H), TOUT2H) to be designed as fixed contact elements.

In accordance with a further preferred embodiment, ground (GND) is fixedly assigned to a fixed contact element, whereas four variable contact elements are each settable as any desired combination of signal inputs (IN1, IN2) and switch outputs (TOUT1, TOUT2). In this embodiment, connection examples for security switches and security light barriers can also be realized with only five contact elements (without housing contact), as will still be described in more detail with reference to the Figure description.

An alternative solution with an anticoincidence connection is also advantageously possible, wherein a fixed contact element is fixedly fixed with functional earth (FE), a fixed contact element with ground (GND) and a fixed contact element with static supply voltage, whereas two variable contact elements are each variably settable as signal inputs with a pull-up resistance or with a pull-down resistance (IN1-pu, IN2-pu, IN1-pd, IN2-pd). Alternatively to this, it is also possible that one of the variable signal inputs is fixedly assigned as a signal input with a pull-down resistance IN1-pd by a fixed contact element. The advantage of this variant lies in the fact that the connection of a contact free protective device (ESPE) and of a security switch can take place at identical contact elements and thus only four contact elements are required at the coupling apparatus. A functional earth can therefore be assigned to the fifth contact element of a 5 pin plug connection. The costs for a coupling apparatus in accordance with the invention can thereby be further reduced. However, on the connection of an ESPE, the signal inputs would then have to be programmed as pull-down inputs.

It is achieved by the coupling apparatus in accordance with the invention that a maximum of six contact elements are required for the connection of the most varied kinds of standard sensors and security sensors. The connection technique in accordance with protection class IP 67 can thus be used with cost favorable M12 5 pin plug connections (optionally with functional earth at the housing).

Further advantageous embodiments of the invention are recited in the dependent claims.

The invention will be described in more detail in the following with reference to embodiments and to the drawings, in which are shown:

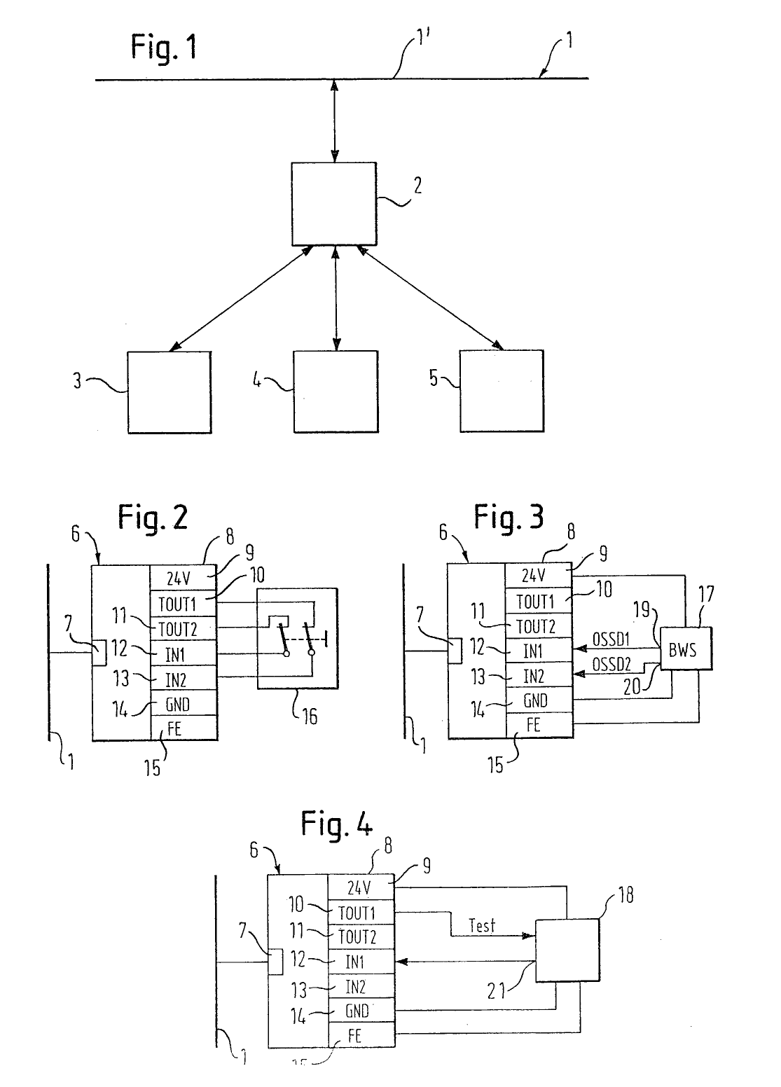

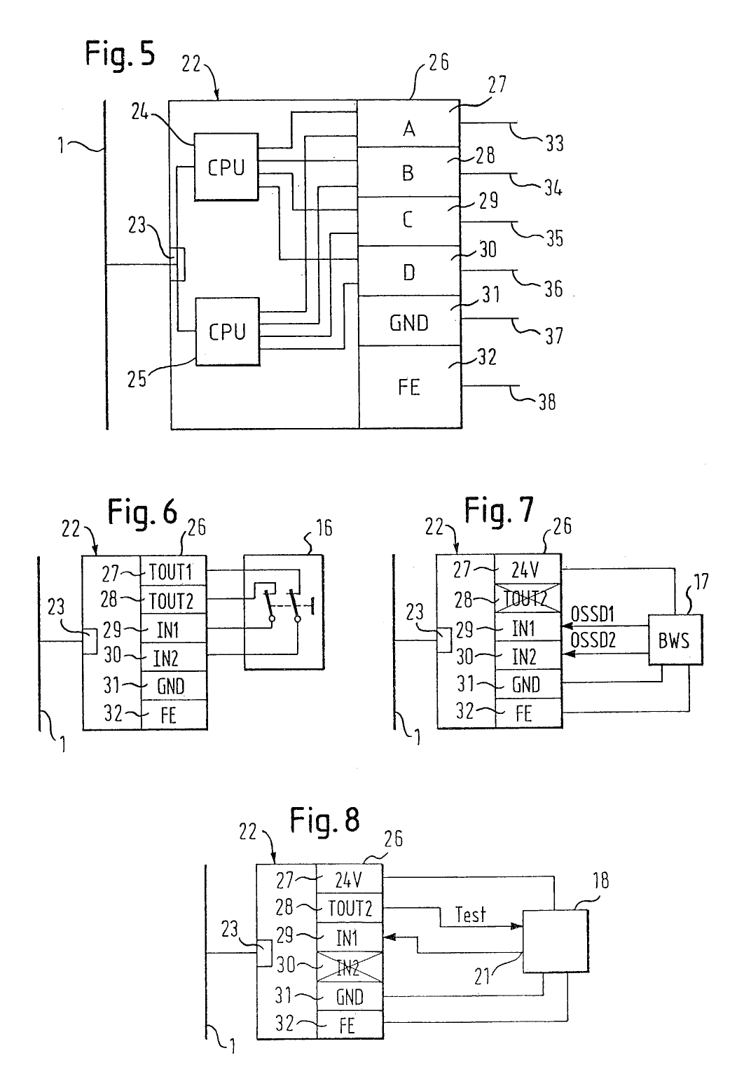

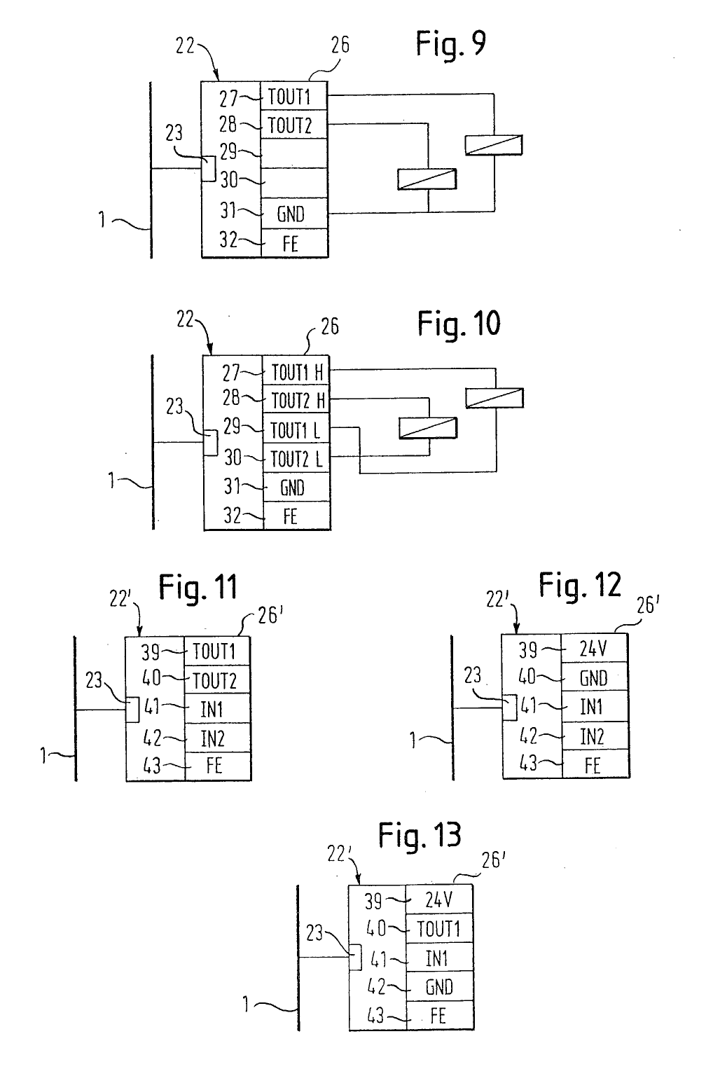

FIG. 1 a block diagram of a bus system to which three different devices are connected via a coupling apparatus in accordance with the invention;

FIGS. 2-4 schematic representations of a coupling apparatus in accordance with the prior art with different circuits;

FIG. 5 a schematic representation of the design of a coupling apparatus made in accordance with the invention; and

FIGS. 6-15 different embodiments of a coupling apparatus made in accordance with the invention with different wiring.

FIG. 1 shows a bus line 1′ of a bus system 1 to which a coupling apparatus 2 in accordance with the invention is connected. Three different devices 3, 4, 5, for example a security switch, a security light barrier and a standard sensor, are connected to the bus line 1′ via the coupling apparatus 2. It is also generally possible for a separate coupling apparatus 2 to be provided for each device 3, 4, 5. By using a coupling apparatus 2 for a plurality of devices 3, 4, 5, the costs of the total system can, however, be reduced.

In FIGS. 2 to 4, a coupling apparatus 6 in accordance with the prior art is shown in a highly schematic manner in each case. Said coupling apparatus is connected in each case to a bus system 1 via a connection unit 7 at the bus side.

Opposite the connection unit 7 at the bus side, a connection unit 8 is provided which is highly schematic and which is usually made as a plug connection. The connection unit 8 at the device side includes seven contact elements 9-15 which are made in practice as contact pins or contact openings of a connection plug or of a connection socket. One of the contact elements can optionally also be made by the housing of the plug or of the socket.

In the coupling apparatuses 6 in accordance with the prior art of FIGS. 2 to 4, a supply voltage (for example 24 volts) is assigned to the contact element 9, the contact element 10 is made as a test output 1 (TOUT1), the contact element 11 as a test output 2 (TOUT2), the contact element 12 as a signal input 1 (IN1), the contact element 13 as a signal input 2 (IN2), potential ground (GND) is assigned to the contact element 14 and the contact element 15 is switched to a functional earth (FE). This internal wiring of the individual contact elements 9 to 5 is fixed and unchangeable.

A coupling apparatus 6 in accordance with the prior can be used with, the selected internal wiring for the connection of a security switch 16 (FIG. 2), of a security light barrier 17 (FIG. 3) or of a testable standard sensor 18 (FIG. 4).

In order to be able to connect a passive or contact loaded security switch 16 to the bus system 1 via the coupling apparatus 6 in accordance with FIG. 2, the following signals are required: signal input 1 (IN1), signal input 2 (IN2), test output 1 (TOUT1) and test output 2 (TOUT2). Since, in accordance with FIG. 2, the contact elements 10 to 13 are assigned these functional properties, the connection of a security switch 16 to the bus system 1 is thus possible with the coupling apparatus 6 in accordance with FIG. 2.

To recognize a short circuit of the signal paths to 24 volts or GND or a cross fault of the two signal paths, test sequences offset in time must be transmitted via the two test outputs TOUT1 and TOUT2. These measures are required to achieve corresponding security categories in accordance with standard EN 954.

In accordance with FIG. 3, a security light barrier 17 (ESPE) can also be connected to the bus system 1 with the same coupling apparatus 6 in accordance with the prior art. The following signals or contacts are required to connect the security light barrier 17: voltage supply (24 volts), signal input 1 (IN1), signal input 2 (IN2), ground (GND) and functional earth (FE). In accordance with FIG. 3, the contact elements 9 and 12 to 15 are assigned these functional properties so that the connection of the security light barrier 17 to the bus system 1 via the coupling apparatus 6 is possible.

In this case, the security light barrier 17 automatically transmits test sequences to its signal outputs 19, 20 (OSSD—output signal switching device in accordance with IEC 61496). Generally, the same signal inputs IN1 and IN2 as in FIG. 2 can be used, with only a reparameterization of the corresponding evaluation software being required.

In the connection of a testable standard sensor 18 in accordance with FIG. 4 to the bus system 1, the following signals are required: voltage supply (24 volts), test output 1 (TOUT1), signal input 1 (IN1), ground (GND) and functional earth (FE). These functional properties are realized in accordance with FIG. 4 by the contact elements 9, 10, 12, 14 and 15 such that with the connection in accordance with FIG. 4, the operation of a testable standard sensor is also possible.

The sensor 18 is tested via the test output TOUT1. The sensor 18 switches off its output 21 with a test signal zero volts so that the function of the sensor 18 can be tested. The output signal of the sensor 18 is read via the signal input IN1.

It is disadvantageous in the coupling apparatus 6 in accordance with the prior art shown in FIGS. 2 to 4 that at least seven contact elements 9 to 15 must be present for the connection of the three shown kinds of transducers to one single kind of coupling apparatus.

As already described, this is associated with problems, since corresponding industrially standardized plug connections at not customary on standard sensors, can only conduct limited currents, cannot be configured by the user himself and have dimensions which are too large. The use of such plug connections is thus associated with increased costs.

In FIG. 5, a coupling apparatus 22 made in accordance with the invention is shown in highly schematic form as a block diagram. The coupling apparatus 22 includes a connection unit 23 at the bus side via which it is connected to the bus system 1. Internally, the connection unit 23 is associated with two internal control units 24, 25 made as CPUs.

A connection unit 26 at the bus side, which includes six contact elements 27 to 32, is provided in turn at the side of the coupling apparatus 22 opposite the connection unit 23 at the bus side. The contact elements 27 to 30 are made as so-called variable contact elements which are each internally connected to the control units 24, 25. Pre-determined functional properties A, B, C, D can be assigned to each of the variable contact elements 27 to 30 via the control units 24, 25, with these functional properties being selectable from a pre-determined set of functional properties.

The contact elements 31 and 32 are, in contrast, made as so-called fixed contact elements, i.e. these two contact elements have fixedly predetermined functional properties, in the example of FIG. 5, the functional properties ground (GND) and functional earth (FE), fixedly assigned to them.

Each of the contact elements 27 to 35 can be connected to corresponding inputs and outputs of devices via indicated connection leads 33 to 38, as will be described in more detail in the following with reference to FIGS. 6 to 15.

In FIG. 6, the connection of the security switch 16 of FIG. 2 to the coupling apparatus 22 made in accordance with the invention is shown. In order to be able to connect the security switch 16, as already mentioned with reference to FIG. 2, the signals IN1, IN2, TOUT1 and TOUT2 are required. Accordingly, in accordance with FIG. 6, in the coupling apparatus 22 made in accordance with the invention, the contact elements 27 to 30 are assigned the functional properties TOUT1, TOUT2, IN1 and IN2 by the control units 24, 25. The fixed contact elements 31, 32 are not required in this case.

On the reading in of corresponding security switches 16 (tactile sensors, non-stop sensors), the internal contact of the switch 16 (opener or closer) is connected to a test output (TOUT1, power source) and to a signal input (IN1, power sink) of the coupling apparatus 2. For a higher security category, this is designed with two channels, as is shown in FIG. 6. The discovery of cross faults between these two channels takes place via transmitted test impulses which are read back via the input with a closed contact. The test impulses are offset in time in the two channels to make possible the recognition of cross faults possible.

The reading out or the test of the security switch 16 thus takes place identically to the use of coupling apparatus in accordance with the prior art in accordance with FIG. 2 on the use of a coupling apparatus made in accordance with the invention such that no adjustment on the part of the user is required here.

If, instead of the security switch 16, the security light barrier 17 in accordance with FIG. 3 should be connected to the coupling apparatus 22 made in accordance with the invention, an assignment in accordance with FIG. 7 is required.

In this case, a supply voltage (24 volts) is assigned to the contact element 27, IN1 to the contact element 29 and IN2 to the contact element 30.

The connection of the security light barrier 17 then takes place identically in accordance with the connection of FIG. 3, with it being ensured by the variable association of the individual functional properties to the contact elements 27 to 30 that the desired functionality in accordance with FIG. 3 is achieved with the wiring shown in accordance with FIG. 7.

The contact element 28 is not required with this wiring so that here this contact element 28 can either be wired to the standard value TOUT2 or also to any other desired functional property. It is likewise possible for the contact element 28 not to be wired in this case, as is represented by a cross in FIG. 7.

As in accordance with the wiring in accordance with FIG. 7, the two channel tested outputs OSSD1 and OSSD2 of the security light barrier 17 are connected to the two signal inputs IN1, IN2. The power supply of the security light barrier takes place via the contact element 27 with, for example, 24 volts. On the connection, the security light barrier 17 discovers cross faults between the two output leads OSSD1 and OSSD2 as well as short circuits after 24 volts or ground (GND).

FIG. 8 shows the parameterization of the coupling apparatus formed in accordance with the invention on the connection of the standard sensor 18 of FIG. 4. In this case, a voltage supply (24 volts) is assigned to the contact element 27, TOUT2 to the contact element 28 and IN1 to the contact element 29. The contact element 30 is in this case not necessary and can be assigned the standard value IN2, for example, or also be unwired, as is indicated by a cross in FIG. 8.

The wiring is identical to the wiring shown in FIG. 4 so that the same functionality as with the coupling apparatus in accordance with the prior art in accordance with FIG. 4 is achieved with the corresponding parameterization of the contact elements 27 to 29.

The standard sensor 18 receives its voltage supply (24 volts) via the contact element 27. The sensor 18 is tested via the test output TOUT2 (contact element 28), while the switch output 21 of the sensor is read in via the contact element 29 (IN1).

Furthermore, by the connection of potential-bound sensors, which require an external test, secure connections can be realized in connection with the associated certified software modules. The modules then carry out corresponding device specific tests and monitoring algorithms.

For two channel security outputs, the two contact elements 27 and 28 can be designed in accordance with FIG. 9 as self-testing secure switch outputs TOUT1 and TOUT2. The security category 4 in accordance with EN 954 or SIL 3 in accordance with IEC 62508 can herewith be achieved. If a lower security category is sufficient, the embodiment can also take place in one channel.

The required control is in turn carried out by the integrated control units 24 and 25 which are controlled by corresponding control signals transmitted via the bus system 1.

For the realization of two pin security outputs, the two contact elements 27, 28 can be realized as high-active switch outputs TOUT1H and TOUT2H, whereas the two contact elements 29 and 30 are parameterized as low-active switch outputs TOUT1L and TOUT2L, as is shown in FIG. 10. It must be pointed out here that in the whole description switch outputs which are not explicitly otherwise designated are generally to be understood as, high-active switch outputs. Generally, the invention can, however, also be used with coupling apparatuses with low-active switch outputs.

The contact elements 31 and 32 are also not needed with this connection, as can be recognized from FIG. 10. Generally, these can in turn, as shown in FIG. 5, be made as fixed contact elements. It is, however, also possible for all contact elements 27 to 32 to be made as variable contact elements and thus to achieve an increased flexibility.

In the embodiments in accordance with FIGS. 6 to 10, a total of six contact elements 27 to 32 are present in each case. The contact element 32 can preferably be made as a housing contact of the connection unit 26 at the device side and can in particular have a functional earth (FE) assigned to it, as was also shown in the embodiments. It is possible in this manner to use cost favorable 5 pin plug connectors, as was already presented initially in detail.

The embodiments in accordance with FIGS. 11 to 15 differ with respect to the embodiments in accordance with FIGS. 6 to 10 in that only five contact elements 39 to 43 are provided. Accordingly, the coupling apparatuses with respect to these Figures are designated by 22′ and the connection units at the device side by 26′. FIGS. 11 to 15 show further possible parameterizations of the contact elements 39 to 43. In FIG. 11, for example, the contact elements 39 and 40 are thus parameterized as test outputs TOUT1, TOUT2, the contact elements 41 and 42 as signal inputs IN1, IN2 and the contact element 43 as the functional earth FE. It is generally also possible for the contact element 43 to be made, for example, not as a variable contact element, but as a fixed contact element in order thus to reduce the internal circuit effort for the coupling apparatus 22′ in accordance with the invention. With the assignment shown in FIG. 11, the connection of a security switch 16 in accordance with FIG. 2 is then, for example, possible.

If, in accordance with FIG. 12, a parameterization is carried out such that a voltage supply is assigned to the contact element 39 and ground (GND) to the contact element 40, the security light barrier 17 in accordance with FIG. 3 can, in contrast, be connected to the coupling apparatus 22′.

On the parameterization in accordance with FIG. 13, in which with respect to FIG. 12 test output TOUT1 is now assigned to the contact element 40 and ground (GND) to the contact element 42, the connection of the standard sensor 18 in accordance with FIG. 4 is possible, in contrast.

It can be seen from FIGS. 11 to 13 that the functional earth FE can be directly connected to the contact element 43 in each case such that, in this embodiment, the use of the housing contact is not necessary. The costs can thereby again be reduced.

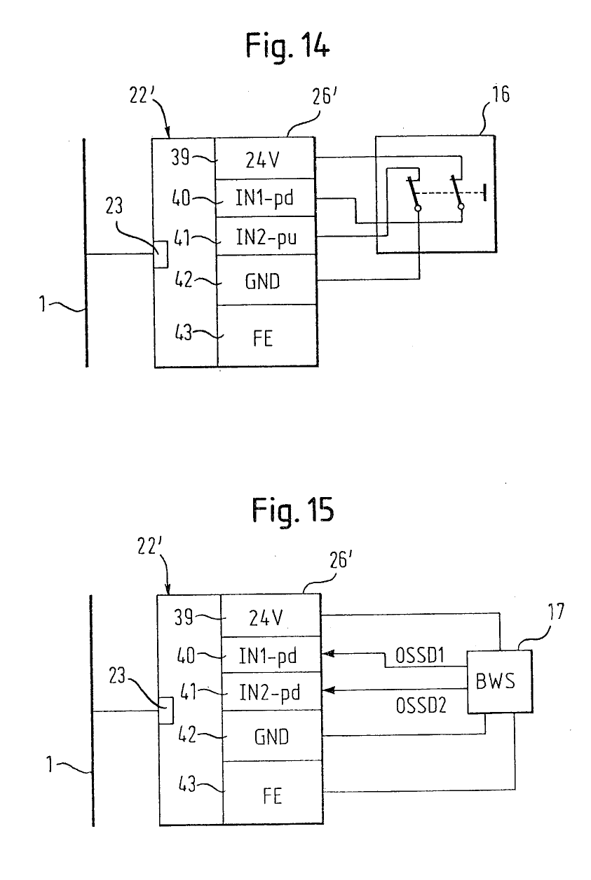

Finally, an anticoincidence coupling apparatus is also possible with the coupling apparatus in accordance with the invention. For this purpose, in accordance with FIG. 14, for example, a voltage supply is assigned to the contact element 39, a signal input 1 to the contact element 40, a signal input 2 to the contact element 41 and ground (GND) to the contact element 42. The contact element 43 can in turn have a functional earth assigned to it either fixedly or variably. The contact elements 40 and 41 are designed as signal inputs with the internal pull-down resistance or the internal pull-up resistance, as is characterized by the designations IN1-pd or IN2-pu respectively. In this variant, it is furthermore possible also to form the contact elements 39 and 42 as fixed contact elements with the assignment shown and only to provide the contact elements 40 and 41 as variable contact elements.

As can be seen from FIG. 15, the connection of the security light barrier 17 is namely possible to the identical contact elements such that in turn only four contact elements are required for the actual connection of the security light barrier and thus the functional earth can be placed on the fifth contact element. The connection via the plug housing is in this case in turn not required.

### Reference Numeral List

1 bus system

1′ bus line

2 coupling apparatus

3 security switch

4 security light barrier

5 standard sensor

6 coupling apparatus

7 connection unit at the bus side

8 connection unit at the device side

9 contact element

10 contact element

11 contact element

12 contact element

13 contact element

14 contact element

15 contact element

16 security switch

17 security light barrier

18 testable standard sensor

19 signal output

20 signal output

21 output

22 coupling apparatus

22′ coupling apparatus

23 connection unit at the bus side

24 internal control unit

25 internal control unit

26 connection unit at the device side

26′ connection unit at the device side

27 contact element

28 contact element

29 contact element

30 contact element

31 contact element

32 contact element

33 connection line

34 connection line

35 connection line

36 connection line

37 connection line

38 connection line

39 contact element

40 contact element

41 contact element

42 contact element

43 contact element

1. A coupling apparatus for the connection of devices (16, 17, 18) such as sensors, actuators, contact free protection devices (electro-sensitive equipment—ESPE), light barriers or controls to a bus system (1), comprising at least one connection unit (23) at the bus side for the connection of the coupling apparatus (22, 22′) to the bus system (1) and comprising at least one connection unit (26, 26′) for the connection of a device (16, 17, 18) to the coupling apparatus (22, 22′), with the connection unit (23) at the device side including n (n>1) contact elements (37-32, 39-43) of which each has one predefined functional property from a set of m (m>1) pre-defined functional properties (A, B, C, D),
characterized in that at least some of the contact elements are made as variable contact elements (27-30, 39-42) to each of which one of the pre-defined functional properties (A, B,C, D) can be variably assigned.

2. A coupling apparatus in accordance with claim 1, characterized in that some of the contact elements are made as fixed contact elements (31, 32, 43) to each of which are fixedly assigned one predetermined functional property (GND, FE), whereas any one functional property (A, B, C, D) can be assigned to any one of the remaining variable contact elements (27-30, 39-42).

3. A coupling apparatus in accordance with claim 1, characterized in that at least some of the variable contact elements (27-30, 39-42) can each be assigned the same functional property (A, B, C, D).

4. A coupling apparatus in accordance with claim 1, characterized in that at least some of the variable contact elements (27-30, 39-42) can be assigned functional properties (A, B, C, D) different from one another.

5. A coupling apparatus in accordance with claim 1, characterized in that the number m of the contact elements (37-32, 39-43) at the device side is larger than, equal to or smaller than the number n of the pre-defined functional properties (A, B, C, D).

6. A coupling apparatus in accordance with claim 1, characterized in that the pre-defined functional properties (A, B, C, D) can be selected from the following properties: static supply voltage (positive or negative), ground (GND), signal input, test output, functional earth, switch output, signal input with pull-up resistance, signal input with pull-down resistance, zero volts and no function.

7. A coupling apparatus in accordance with claim 1, characterized in that one of the contact elements (32) is made as a housing part of the connection unit (26, 26′) at the device side.

8. A coupling apparatus in accordance with claim 1, characterized in that the coupling apparatus (22, 22′) is made for the connection of secure units (security units) (16, 17).

9. A coupling apparatus in accordance with claim 1, characterized in that the coupling apparatus (22, 22′) is made for the connection to a secure bus system (security bus system) (1).

10. A coupling apparatus in accordance with claim 1, characterized in that the connection unit (26′) at the device side includes five contact elements (39-43).

11. A coupling apparatus in accordance with claim 1, characterized in that the connection unit (26) at the device side includes six contact elements (27-32), with one of the contact elements (42) being formed as a housing contact, i.e. as a housing part of the connection unit (26) at the device side.

12. A coupling apparatus in accordance with claim 11, characterized in that a functional earth (FE) is fixedly assigned to the housing contact (32).

13. A coupling apparatus in accordance with claim 1, characterized in that a fixed contact element (29) is fixedly set as a first signal input (IN1), a fixed contact element (30) as a second signal input (IN2) and a fixed contact element (3) as ground (GND), whereas two variable contact elements can each be variably set as the first or second test outputs (TOUT1, TOUT2) or can have a static supply voltage or 0 V assigned to them.

14. A coupling apparatus in accordance with claim 1, characterized in that a fixed contact element (31) is fixedly set as ground (GND), whereas two variable contact elements (27, 28) can be respectively set as the first and second test outputs (TOUT1H, TOUT2H) and two further variable contact elements (29, 30) as respective low-active first and second switch outputs (TOUT1L, TOUT2L).

15. A coupling apparatus in accordance with claim 1, characterized in that a fixed contact element (27) is fixedly set as a first switch output (TOUT1H), a fixed contact element (28) as a second switch output (TOUT2H) and a fixed contact element (31) as ground (GND), whereas two variable contact elements (29, 30) can be variably set as respective first and second signal inputs (IN1, IN2) or as respective low-active first and second switch outputs (TOUT1L, TOUT2L).

16. A coupling apparatus in accordance with claim 1, characterized in that ground (GND) is fixedly assigned to a fixed contact element (31), whereas four variable contact elements (27-30) can respectively be variably set as any desired combination of signal inputs (IN1, IN2) and switch outputs (TOUT1, TOUT2).

17. A coupling apparatus in accordance with claim 1, characterized in that a functional earth (FE) is fixedly assigned to a fixed contact element (43), whereas four variable contact elements (39-42) can respectively be variably set as any desired combination of signal inputs (IN1, IN2), switch outputs (TOUT1, TOUT2), ground (GND) and a static supply voltage.

18. A coupling apparatus in accordance with claim 1, characterized in that a functional earth (FE) is fixedly assigned to a fixed contact element (43), ground (GND) to a fixed contact element (42) and a static supply voltage to a fixed contact element (39), whereas two variable contact elements (40, 41) can respectively be variably set as signal inputs with a pull-up resistance or with a pull-down resistance (IN1-pu, IN2-pu, IN1-pd, IN2-pd).

19. A coupling apparatus in accordance with claim 1, characterized in that a functional earth (FE) is fixedly assigned to a fixed contact element (43), ground (GND) to a fixed contact element (42), a static supply voltage to a fixed contact element (39) and a signal input with pull-down resistance (IN1-pd) to a fixed contact element (40), whereas a variable contact element (41) can be variably set as a signal input with a pull-up resistance (IN2-pu) or as a signal input with a pull-down resistance (IN2-pd).

20. A coupling apparatus in accordance with claim 1, characterized in that at least one internal control unit (24, 25) is provided inside the coupling apparatus (22, 22′) and the assignment of the functional properties (A, B, C, D) to the variable contact elements (27-30) can be controlled via it.

21. A coupling apparatus in accordance with claim 20, characterized in that the internal control unit (24, 25) includes a software control module.

22. A coupling apparatus in accordance with claim 20, characterized in that two redundant internal control units (24, 25) are provided for the production of a secure coupling apparatus (22, 22′).

23. A coupling apparatus in accordance with claim 1, characterized in that an external control unit, in particular a personal computer, via which the internal control unit(s) (24, 25) is/are controllable, can be connected for the assignment of the variable contact elements (27-30).

24. A coupling apparatus in accordance with claim 23, characterized in that a separate control connection is provided for the connection of the external control unit to the coupling apparatus.

25. A coupling apparatus in accordance with claim 23, characterized in that control data can be transmitted from the external control unit via the bus system (1) and via the connection unit (23) at the bus side to the coupling apparatus (22, 22′).

26. A coupling apparatus in accordance with claim 1, characterized in that the connection unit at the device side is designed as a five pin plug connector or as a five pin plug connector with a housing contact as a sixth pin.

27. A coupling apparatus in accordance with claim 26, characterized in that the connection unit at the device side is designed as an M12 5-pin round plug connector or as an M 12 5-pin round plug connector with housing shield.
